(19) United States
(12) Patent Application Publication
(10) Pub. No.: US 2007/0169074 A1
(43) Pub. Date: Jul. 19, 2007

(54) Upgrade apparatus and its method for home network system

(76) Inventors: Ja-In Koo, Kyungsangnam-do (KR); Feel-Young Koo, Busan (KR); Hwan-Jong Choi, Busan (KR); Seong-Hwan Kang, Kyungsangnam-do (KR); Yong-Tae Kim, Kyungsangnam-do (KR); Koon-Seok Lee, Kyungsangnam-do (KR); Seung-Myun Baek, Kyungsangnam-do (KR)

Correspondence Address: Song K Jung;McKenna Long & Aldridge, 1900 K Street N W, Washington, DC, 20006, US

(21) Appl. No.: 10/562,701

(22) PCT Filed: Jul. 7, 2003
(86) PCT No.: PCT/KR03/01337

§ 371 Date: Jun. 5, 2006

(51) Int. Cl. G06F 9/44

(52) U.S. Cl. 717/168

(57) ABSTRACT

The present invention discloses an upgrade apparatus and its method for a home network system which can automatically upgrade software. The upgrade apparatus for the home network system is installed in the home network system having a first storage unit in which at least one protected program has been installed, and includes n upgrade means for deciding whether a second storage unit separated from the first storage unit stores an upgrade file corresponding to the protected program, and upgrading the protected program by using the upgrade file according to the decision result.

### TECHNICAL FIELD

The present invention relates to a home network system, and more particularly to, an upgrade apparatus and its method for a home network system which can automatically upgrade software.

### BACKGROUND ART

Home automation for automatically controlling home appliances at home or remotely has almost reached a commercial use stage. At its early stage, the home automation separately controlled each home appliance by using a telephone or infrared rays, and did not connect the home appliances one another. However, there has been suggested a method for building a network of home appliances by using a communication means, and collectively managing the network by using a controller.

FIG. 1 is a structure view illustrating a general home network system. Referring to FIG. 1, a home network connects various digital home appliances so that a user can always enjoy convenient, safe and economic life services inside or outside the house.

As factors of the advent of the home network, refrigerators or washing machines called white home appliances have been gradually digitalized due to development of digital signal processing techniques, and new information home appliances have been made due to rapid development of home appliance operating system techniques and high speed multimedia communication techniques.

Here, an IT network is built to exchange data between a personal computer and peripheral devices or provide internet services, and an AV network is built between home appliances using audio or video information. In addition, a living network is built to simply control home appliances, such as home automation or remote meter reading, and may be comprised of a refrigerator, washing machine, microwave oven, electric lamp, gas alarm, air conditioner and telephone.

Each home appliance of the home network system needs to continuously develop application techniques and upgrade software or firmware installed inside during the production for stable operations. However, the conventional arts have never suggested a detailed upgrade technique or method of the home network system.

In addition, each of the home appliances of the home network system includes system programs for inside system operations, and application programs and system management data (hereinafter, referred to as ‘protected programs’). Such protected programs may be mistakenly deleted by the user or natural or human-initiated damages, or may be damaged due to disk formatting or viruses. A storage unit protecting program is stored and executed to protect the protected programs. That is, even if the inside or outside user freely changes the protected program, the storage unit protecting program performs an operation for restoring the protected program which has been changed due to a reset operation (namely, power is off, and then on).

However, the following problems may happen in each home appliance of the home network system where the storage unit protecting program is executed.

FIG. 2 is a flowchart showing a conventional upgrade method of the home network system in which the storage unit protecting program is being executed.

In detail, in S10, power is supplied to the home appliance for the home network system, and in S11, the storage unit protecting program is executed to protect system files and/or general programs.

In S12, the protected program is executed. Here, the protected program is installed in the home appliance before the installation of the storage unit protecting program. When power is supplied, the protected program is executed in the initial installation status by the storage unit protecting program.

In S13, the user transmits an upgrade command for the protected program to the home appliance, to upgrade the protected program from an external server.

In S14, power is off, and the routine ends. When power is supplied again, S10 and S11 are repeated. In S12, the protected program is executed in the initial installation status, not the upgrade status, which results from the general operation principles of the storage unit protecting program.

Accordingly, the home appliance in which the storage unit protecting program has been installed does not continuously maintain the upgrade status but returns to the initial status. Moreover, the user must manually upgrade the home appliance after power supply.

### DISCLOSURE OF THE INVENTION

An object of the present invention is to provide an upgrade apparatus and its method for a home network system which can automatically upgrade the home network system and/or each home appliance.

Another object of the present invention is to provide an upgrade apparatus and its method for a home network system which receive upgrade files for home appliances which are sub-devices of the home network system from an external server, and automatically upgrade the home appliances.

Yet another object of the present invention is to provide an upgrade apparatus and its method for a home network system which can automatically upgrade a home appliance in which a storage unit protecting program has been installed.

Yet another object of the present invention is to provide an upgrade apparatus and its method for a home network system which include first and second storage units separated from each other, for upgrading protected programs and sub-devices.

In order to achieve the above-described objects of the invention, there is provided an upgrade apparatus for a home network system which is installed in the home network system having a first storage unit in which at least one protected program has been installed, and which includes an upgrade means for deciding whether a second storage unit separated from the first storage unit stores an upgrade file corresponding to the protected program, and upgrading the protected program by using the upgrade file according to the decision result.

Preferably, a first storage unit protecting program is installed in the first storage unit, and the upgrade means upgrades the protected program after the first storage unit protecting program is executed.

Preferably, the upgrade apparatus further includes: a connection means for communication with an external server; and a control means for transmitting upgrade information for the protected program stored in the second storage unit to the external server through the connection means, and receiving upgrade data containing a new upgrade file and upgrade information for the protected program from the external server.

Preferably, the control means stores the upgrade data in the second storage unit.

Preferably, the upgrade means reads the upgrade file from the second storage unit, and upgrades the protected program.

Preferably, the control means deletes the upgrade information previously stored in the second storage unit.

Preferably, the second storage unit is logically separated from the first storage unit.

Preferably, the second storage unit is physically separated from the first storage unit.

According to another aspect of the invention, an upgrade method for a home network system including a first storage unit in which at least one protected program has been installed includes the steps of: deciding whether a second storage unit separated from the first storage unit stores an upgrade file corresponding to the protected program; and upgrading the protected program by using the upgrade file according to the decision result.

Preferably, when a first storage unit protecting program is installed in the first storage unit, the decision step is performed after the first storage unit protecting program is executed.

Preferably, the upgrade method further includes the steps of: accessing an external server; transmitting upgrade information for the protected program stored in the second storage unit to the external server; receiving upgrade data containing a new upgrade file and upgrade information for the protected program from the external server; and storing the upgrade data in the second storage unit.

Preferably, the upgrade method further includes a step for reading the new upgrade file from the second storage unit, and upgrading the protected program.

Preferably, the upgrade method further includes a step for deleting the upgrade information previously stored in the second storage unit.

According to another aspect of the invention, a program storage medium stores a computer readable program which is provided to a home network system including a first storage unit in which at least one protected program has been installed, and which includes the steps of: deciding whether a second storage unit separated from the first storage unit stores an upgrade file corresponding to the protected program; and upgrading the protected program by using the upgrade file according to the decision result.

Preferably, when a first storage unit protecting program is installed in the first storage unit, the program is executed after the first storage unit protecting program is executed.

Preferably, the program further includes the steps of: accessing an external server; transmitting upgrade information for the protected program stored in the second storage unit to the external server; receiving upgrade data containing a new upgrade file and upgrade information for the protected program from the external server; and storing the upgrade data in the second storage unit.

Preferably, the program further includes a step for reading the new upgrade file from the second storage unit, and upgrading the protected program.

Preferably, the program further includes a step for deleting the upgrade information previously stored in the second storage unit.

According to another aspect of the invention, an upgrade apparatus for a home network system is installed in the home network system communicating with at least one sub-device and including a first storage unit in which at least one protected program has been installed, and includes: a connection means connected to an external server, for transmitting upgrade information stored in a second storage unit separated from the first storage unit to the external server, and receiving upgrade data containing a new upgrade file and upgrade information from the external server; a control means for storing the new upgrade information, deciding whether the upgrade file relates to the sub-device or protected program, and transmitting the upgrade file to the sub-device or storing the upgrade file in the second storage unit according to the decision result; and an upgrade means for upgrading the protected program corresponding to the upgrade file.

Preferably, the upgrade information relates to the sub-device and the protected program.

Preferably, a first storage unit protecting program is installed in the first storage unit, and the upgrade means upgrades the protected program after the first storage unit protecting program is executed.

Preferably, the upgrade means decides whether the second storage unit stores the upgrade file corresponding to the protected program, and upgrades the protected program by using the upgrade file according to the decision result, after the first storage unit protecting program is executed and before the connection means is connected to the external server.

Preferably, the control means deletes the upgrade information previously stored in the second storage unit.

Preferably, the second storage unit is logically separated from the first storage unit.

Preferably, the second storage unit is physically separated from the first storage unit.

According to another aspect of the invention, an upgrade method for a home network system communicating with at least one sub-device and including a first storage unit in which at least one protected program has been installed includes the steps of: accessing an external server; transmitting upgrade information stored in a second storage unit separated from the first storage unit to the external server; receiving upgrade data containing new upgrade information and a new upgrade file from the external server; storing the new upgrade information; deciding whether the upgrade file relates to the sub-device or protected program; transmitting the upgrade file to the sub-device or storing the upgrade file in the second storage unit according to the decision result; and

upgrading the protected program corresponding to the upgrade file stored in the second storage unit.

Preferably, the upgrade information relates to the sub-device and the protected program.

Preferably, the upgrade method further includes a step for executing a first storage unit protecting program before the upgrade step, when the first storage unit protecting program is installed in the first storage unit.

Preferably, the upgrade method further includes the steps of: deciding whether the second storage unit stores the upgrade file corresponding to the protected program; and upgrading the protected program according to the decision result, after the step for executing the first storage unit protecting program and before the step for accessing the external server.

Preferably, the upgrade method further includes a step for deleting the upgrade information previously stored in the second storage unit.

According to another aspect of the invention, a program storage medium stores a computer readable program which is provided to a home network system communicating with at least one sub-device and including a first storage unit in which at least one protected program has been installed, and which includes the steps of: accessing an external server; transmitting upgrade information stored in a second storage unit separated from the first storage unit to the external server; receiving upgrade data containing new upgrade information and a new upgrade file from the external server; storing the new upgrade information; deciding whether the upgrade file relates to the sub-device or protected program; transmitting the upgrade file to the sub-device or storing the upgrade file in the second storage unit according to the decision result; and upgrading the protected program corresponding to the upgrade file stored in the second storage unit.

Preferably, the upgrade information relates to the sub-device and the protected program.

Preferably, the program further includes a step for executing a first storage unit protecting program before the upgrade step, when the first storage unit protecting program is installed in the first storage unit.

Preferably, the program further includes the steps of: deciding whether the second storage unit stores the upgrade file corresponding to the protected program; and upgrading the protected program according to the decision result, after the step for executing the first storage unit protecting program and before the step for accessing the external server.

Preferably, the program further includes a step for deleting the upgrade information previously stored in the second storage unit.

### BRIEF DESCRIPTION OF THE DRAWINGS

FIG. 1 is a structure view illustrating a general home network system;

FIG. 2 is a flowchart showing a conventional upgrade method for a home network system in which a storage unit protecting program is being executed;

FIG. 3 is a structure view illustrating a home network system in which an upgrade apparatus has been installed in accordance with the present invention;

FIG. 4 is a structure view illustrating an upgrade apparatus in accordance with a first embodiment of the present invention;

FIG. 5 is a flowchart showing an upgrade method using the upgrade apparatus of FIG. 4;

FIG. 6 is a structure view illustrating an upgrade apparatus in accordance with a second embodiment of the present invention; and

FIG. 7 is a flowchart showing an upgrade method using the upgrade apparatus of FIG. 6.

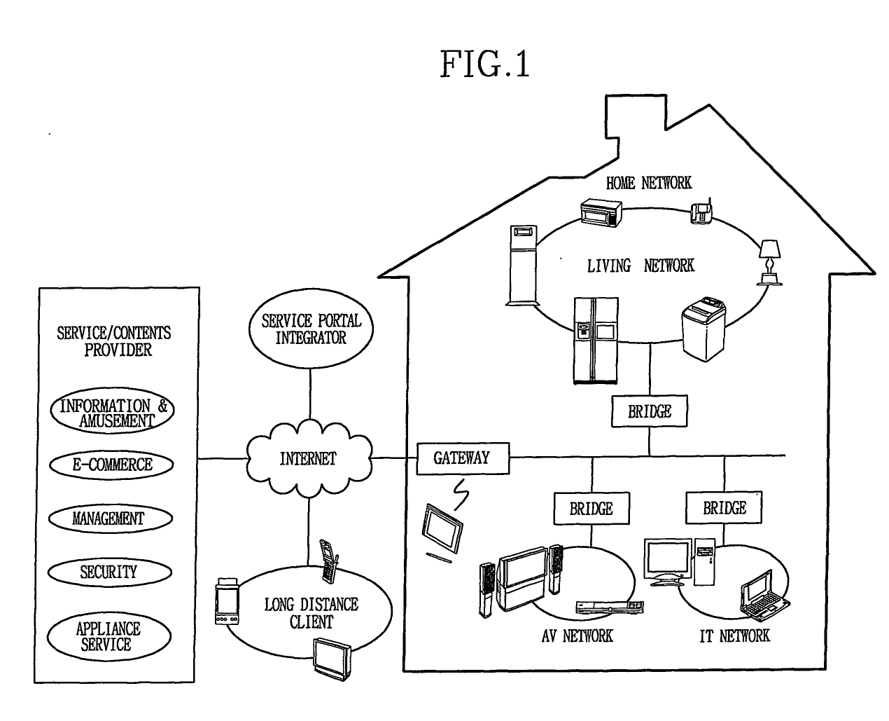

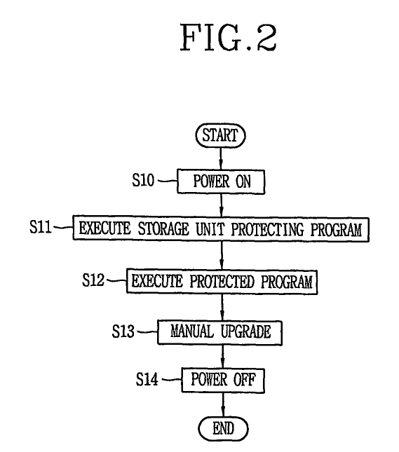

### BEST MODE FOR CARRYING OUT THE INVENTION

An upgrade apparatus and its method for a home network system in accordance with the present invention will now be described in detail with reference to the accompanying drawings.

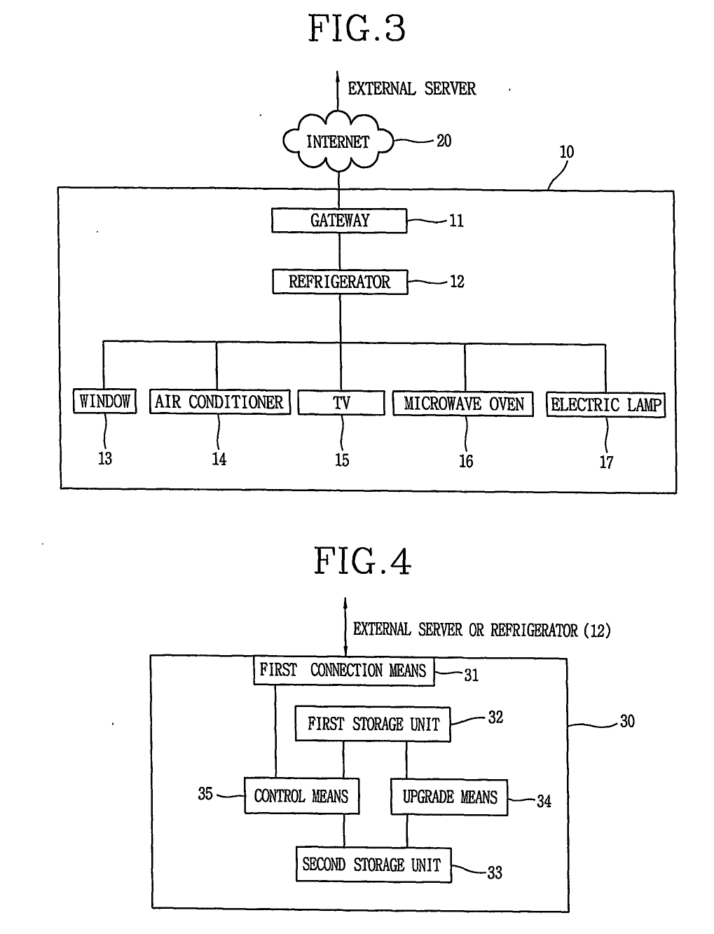

FIG. 3 is a structure view illustrating the home network system in which the upgrade apparatus has been installed in accordance with the present invention. Referring to FIG. 3, the home network system 10 is connected to an external server (not shown) through an internet 20, and includes a gateway 11 for access to the internet 20, and a refrigerator 12 for transmitting data (for example, operation commands, status notifications, etc.) between the other home appliances (window 13, air conditioner 14, TV 15, microwave oven 16 and electric lamp 17) and the external server, and controlling the home network system 10.

The refrigerator 12 serves to control the home appliances which are lower slave devices like a master device of a general network system.

The home appliances of the invention include the home appliances for the living network such as the window 13, the air conditioner 14, the TV 15, the microwave oven 16 and the electric lamp 17 as well as the home appliances for the IT network service and the AV network service.

The home appliances include control means (not shown) for controlling operations, and thus respond to the data from the refrigerator 12 and perform operations according to the data.

FIG. 4 is a structure view illustrating an upgrade apparatus in accordance with a first embodiment of the present invention. As illustrated in FIG. 4, the upgrade apparatus 30 is installed in the refrigerator 12 or other home appliances, and includes a connection means 31 for communication with the external server or refrigerator 12, a first storage unit 32 in which protected programs and a first storage unit protecting program have been installed, a second storage unit 33 for storing upgrade information (for example, upgrade versions and upgrade dates of protected programs) and upgrade files (upgrade contents of protected programs), an upgrade means 34 for respectively upgrading the protected programs of the first storage unit 32 by using the upgrade files of the second storage unit 33, and a control means 35 for transmitting the upgrade information of the second storage unit 33 to the external server or refrigerator 12 through the connection means 31, receiving upgrade data containing new upgrade information data and a new upgrade file, and storing the upgrade data in the second storage unit 33.

The first storage unit 32 and the second storage unit 33 are separated from each other, so that the first storage unit protecting program installed in the first storage unit 32 cannot influence the second storage unit 33. Here, the first storage unit 32 and the second storage unit 33 are physically separated storage units (for example, separated hard disk drives), or physically combined but logically separated storage units.

In addition, the upgrade means 34 and the control means 35 are separated as shown in FIG. 4, or incorporated.

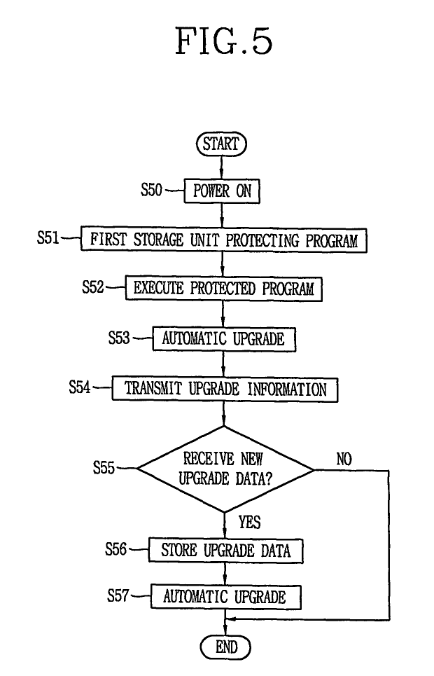

FIG. 5 is a flowchart showing an upgrade method using the upgrade apparatus of FIG. 4.

In detail, in S50, power is supplied to the upgrade apparatus 30, in S51, the first storage unit protecting program of the first storage unit 32 is executed, and in S52, the protected programs of the first storage unit 32 are respectively executed.

In S53, the upgrade means 34 decides whether the second storage unit 33 stores the upgrade files corresponding to the protected programs. When the upgrade files have been stored in the second storage unit 33, the upgrade means 34 respectively upgrades the protected programs by using the upgrade files.

In S54, the control means 35 transmits the upgrade information of the second storage unit 33 to the external server or refrigerator 12 through the connection means 31. The external server analyzes the upgrade information, searches new upgrade information and a new upgrade file, generates upgrade data containing the new upgrade information and upgrade file according to the search result, and transmits the upgrade data to the refrigerator 12 or directly to the upgrade apparatus 30. Generation and transmission of the upgrade data by the external server are easily recognized by those skilled in the art which the present invention pertains to, and thus detailed explanations thereof are omitted.

In S55, the control means 35 decides whether it receives the new upgrade data from the external server or refrigerator 12 through the connection means 31. If the control means 35 does not receive new upgrade data within a predetermined time, or receives a message notifying no new upgrade data, the control means 35 ends the routine. If the control means 35 receives the new upgrade data, the control means 35 goes to S56.

In S56, the control means 35 stores the new upgrade data (upgrade information and upgrade file) in the second storage unit 33. Here, the control means 35 deletes the upgrade information previously stored in the second storage unit 33.

In S57, the upgrade means 34 reads the new upgrade file from the second storage unit 33, and upgrades the corresponding protected program by using the upgrade file.

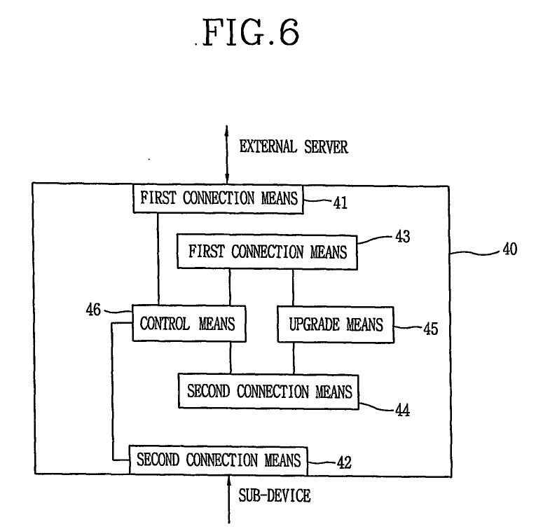

FIG. 6 is a structure view illustrating an upgrade apparatus in accordance with a second embodiment of the present invention. As depicted in FIG. 6, the upgrade apparatus 40 is installed in the refrigerator 12 or gateway 11, and includes a first connection means 41 for communication with the external server, a second connection means 42 for communication with a plurality of sub-devices which are home appliances, a first storage unit 43 in which protected programs and a first storage unit protecting program have been installed, a second storage unit 44 for storing upgrade information (for example, upgrade versions and upgrade dates of protected programs) and upgrade files (upgrade contents of protected programs), an upgrade means 45 for respectively upgrading the protected programs of the first storage unit 43 by using the upgrade files of the second storage unit 44, and a control means 46 for transmitting the upgrade information of the second storage unit 44 to the external server through the first connection means 41, receiving upgrade data containing new upgrade information and a new upgrade file, storing the upgrade information in the second storage unit 44, deciding whether the new upgrade file relates to the protected program or sub-device, and storing the upgrade file in the second storage unit 44 or transmitting the upgrade file to the sub-device through the second connection means 42 according to the decision result.

The first storage unit 43 and the second storage unit 44 are separated from each other, so that the first storage unit protecting program installed in the first storage unit 43 cannot influence the second storage unit 44. Here, the first storage unit 43 and the second storage unit 44 are physically separated storage units (for example, separated hard disk drives), or physically combined but logically separated storage units.

In addition, the upgrade means 45 and the control means 46 are separated as shown in FIG. 6, or incorporated.

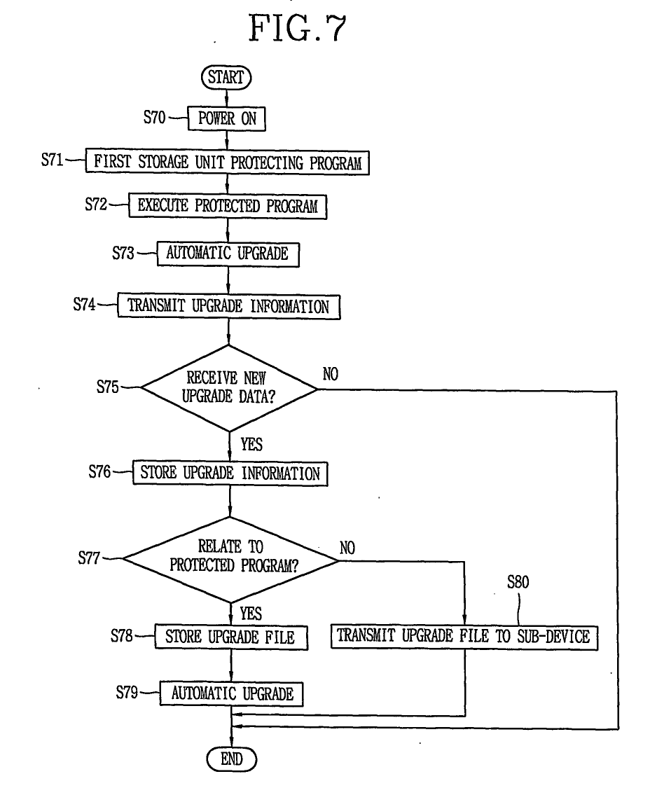

FIG. 7 is a flowchart showing an upgrade method using the upgrade apparatus of FIG. 6.

In detail, in S70, power is supplied to the upgrade apparatus 40, in S71, the first storage unit protecting program of the first storage unit 43 is executed, and in S72, the protected programs of the first storage unit 43 are respectively executed.

In S73, the upgrade means 45 decides whether the second storage unit 44 stores the upgrade files corresponding to the protected programs. When the upgrade files have been stored in the second storage unit 44, the upgrade means 45 respectively upgrades the protected programs by using the upgrade files.

In S74, the control means 46 transmits the upgrade information of the second storage unit 33 to the external server through the first connection means 41.

In S75, the control means 46 decides whether it receives the new upgrade data from the external server through the first connection means 41. If the control means 46 does not receive new upgrade data within a predetermined time, or receives a message notifying no new upgrade data, the control means 46 ends the routine. If the control means 46 receives the new upgrade data, the control means 46 goes to S76.

In S76, the control means 46 stores the new upgrade data (upgrade information and upgrade file) in the second storage unit 44. Here, the control means 46 deletes the upgrade information previously stored in the second storage unit 44.

In S77, the upgrade means 46 decides whether the new upgrade file relates to the protected program installed in the first storage unit 43 or the sub-device connected to the second connection means 42. If the new upgrade file relates to the protected program, the control means 46 stores the new upgrade file in the second storage unit 44 in S78.

In S79, the upgrade means 45 reads the new upgrade file from the second storage unit 44, and upgrades the corresponding protected program by using the upgrade file.

If the new upgrade file relates to the sub-device, the control means 46 transmits the upgrade file to the sub-device through the second connection means 42 in S80.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. An upgrade apparatus for a home network system which is installed in the home network system having a first storage unit in which at least one protected program has been installed, and which comprises an upgrade means for deciding whether a second storage unit separated from the first storage unit stores an upgrade file corresponding to the protected program, and upgrading the protected program by using the upgrade file according to the decision result.

2. The apparatus of claim 1, wherein a first storage unit protecting program is installed in the first storage unit, and the upgrade means upgrades the protected program after the first storage unit protecting program is executed.

3. The apparatus of claim 1, further comprising:
a connection means for communication with an external server, and
a control means for transmitting upgrade information for the protected program stored in the second storage unit to the external server through the connection means, and receiving upgrade data containing a new upgrade file and upgrade information for the protected program from the external server.

4. The apparatus of claim 3, wherein the control means stores the upgrade data in the second storage unit.

5. The apparatus of claim 4, wherein the upgrade means reads the upgrade file from the second storage unit, and upgrades the protected program.

6. The apparatus of claim 4, wherein the control means deletes the upgrade information previously stored in the second storage unit.

7. The apparatus of one of claims 1 to 5, wherein the second storage unit is logically separated from the first storage unit.

8. The apparatus of one of claims 1 to 5, wherein the second storage unit is physically separated from the first storage unit.

9. An upgrade method for a home network system including a first storage unit in which at least one protected program has been installed, comprising the steps of:
deciding whether a second storage unit separated from the first storage unit stores an upgrade file corresponding to the protected program; and
upgrading the protected program by using the upgrade file according to the decision result.

10. The method of claim 9, wherein, when a first storage unit protecting program is installed in the first storage unit, the decision step is performed after the first storage unit protecting program is executed.

11. The method of claim 9, further comprising the steps of:
accessing an external server;
transmitting upgrade information for the protected program stored in the second storage unit to the external server;
receiving upgrade data containing a new upgrade file and upgrade information for the protected program from the external server; and
storing the upgrade data in the second storage unit.

12. The method of claim 11, further comprising a step for reading the new upgrade file from the second storage unit, and upgrading the protected program.

13. The method of claim 12, further comprising a step for deleting the upgrade information previously stored in the second storage unit.

14. A program storage medium for storing a computer readable program which is provided to a home network system including a first storage unit in which at least one protected program has been installed, and which comprises the steps of:
deciding whether a second storage unit separated from the first storage unit stores an upgrade file corresponding to the protected program; and
upgrading the protected program by using the upgrade file according to the decision result.

15. The medium of claim 14, wherein, when a first storage unit protecting program is installed in the first storage unit, the program is executed after the first storage unit protecting program is executed.

16. The medium of claim 14, wherein the program further comprises the steps of:
accessing an external server;
transmitting upgrade information for the protected program stored in the second storage unit to the external server;
receiving upgrade data containing a new upgrade file and upgrade information for the protected program from the external server; and
storing the upgrade data in the second storage unit.

17. The medium of claim 16, wherein the program further comprises a step for reading the new upgrade file from the second storage unit, and upgrading the protected program.

18. The medium of claim 17, wherein the program further comprises a step for deleting the upgrade information previously stored in the second storage unit.

19. An upgrade apparatus for a home network system which is installed in the home network system communicating with at least one sub-device and including a first storage unit in which at least one protected program has been installed, comprising:
a connection means connected to an external server, for transmitting upgrade information stored in a second storage unit separated from the first storage unit to the external server, and receiving upgrade data containing a new upgrade file and upgrade information from the external server;
a control means for storing the new upgrade information, deciding whether the upgrade file relates to the sub-device or protected program, and transmitting the upgrade file to the sub-device or storing the upgrade file in the second storage unit according to the decision result; and
an upgrade means for upgrading the protected program corresponding to the upgrade file.

20. The apparatus of claim 19, wherein the upgrade information relates to the sub-device and the protected program.

21. The apparatus of claim 19, wherein a first storage unit protecting program is installed in the first storage unit, and the upgrade means upgrades the protected program after the first storage unit protecting program is executed.

22. The apparatus of claim 21, wherein the upgrade means decides whether the second storage unit stores the upgrade file corresponding to the protected program, and upgrades the protected program by using the upgrade file according to the decision result, after the first storage unit protecting program is executed and before the connection means is connected to the external server.

23. The apparatus of claim 19, wherein the control means deletes the upgrade information previously stored in the second storage unit.

24. The apparatus of one of claims 19 to 22, wherein the second storage unit is logically separated from the first storage unit.

25. The apparatus of one of claims 19 to 22, wherein the second storage unit is physically separated from the first storage unit.

26. An upgrade method for a home network system communicating with at least one sub-device and including a first storage unit in which at least one protected program has been installed, comprising the steps of:
accessing an external server;
transmitting upgrade information stored in a second storage unit separated from the first storage unit to the external server;
receiving upgrade data containing new upgrade information and a new upgrade file from the external server;
storing the new upgrade information;
deciding whether the upgrade file relates to the sub-device or protected program;
transmitting the upgrade file to the sub-device or storing the upgrade file in the second storage unit according to the decision result; and
upgrading the protected program corresponding to the upgrade file stored in the second storage unit.

27. The method of claim 26, wherein the upgrade information relates to the sub-device and the protected program.

28. The method of claim 26, further comprising a step for executing a first storage unit protecting program before the upgrade step, when the first storage unit protecting program is installed in the first storage unit.

29. The method of claim 28, further comprising the steps of:
deciding whether the second storage unit stores the upgrade file corresponding to the protected program; and
upgrading the protected program according to the decision result, after the step for executing the first storage unit protecting program and before the step for accessing the external server.

30. The method of claim 26, further comprising a step for deleting the upgrade information previously stored in the second storage unit.

31. A program storage medium for storing a computer readable program which is provided to a home network system communicating with at least one sub-device and including a first storage unit in which at least one protected program has been installed, and which comprises the steps of:
accessing an external server;
transmitting upgrade information stored in a second storage unit separated from the first storage unit to the external server;
receiving upgrade data containing new upgrade information and a new upgrade file from the external server;
storing the new upgrade information;
deciding whether the upgrade file relates to the sub-device or protected program;
transmitting the upgrade file to the sub-device or storing the upgrade file in the second storage unit according to the decision result; and
upgrading the protected program corresponding to the upgrade file stored in the second storage unit.

32. The medium of claim 31, wherein the upgrade information relates to the sub-device and the protected program.

33. The medium of claim 31, wherein the program further comprises a step for executing a first storage unit protecting program before the upgrade step, when the first storage unit protecting program is installed in the first storage unit.

34. The medium of claim 33, wherein the program further comprises the steps of:
deciding whether the second storage unit stores the upgrade file corresponding to the protected program; and
upgrading the protected program according to the decision result, after the step for executing the first storage unit protecting program and before the step for accessing the external server.

35. The medium of claim 31, wherein the program further comprises a step for deleting the upgrade information previously stored in the second storage unit.
